(19) United States
(12) Patent Application Publication
(10) Pub. No.: US 2025/0106299 A1
(43) Pub. Date: Mar. 27, 2025

(54) AUTOMATICALLY PERFORMING ROUTINE LOCATION-BASED OPERATIONS

(71) Applicant: Salesforce, Inc., San francisco, CA (US)

(72) Inventors: Puneet Dhaliwal, Dublin, CA (US); Asaf Altagar, Givatayim (IL)

(21) Appl. No.: 18/371,557

(22) Filed: Sep. 22, 2023

(51) Int. Cl. H04L 67/52

(52) U.S. Cl. CPC H04L 67/52

(57) ABSTRACT

A computer-implemented method for automatically performing routine location-based operations. The method includes receiving, at a server, information related to a current location, a current time, and a current status from a client device having a client application. The method also includes responsive to the information related to the current location, the current time, and the current status, configuring, by the server, the client device to automatically perform an operational routine. The operational routine includes at least one of: (i) performing, by the client device, a local action at the current location, (ii) performing, by the client device, a backend action, (iii) prompting, by the client device, a user to perform, using the client application, a first predefined action, and (iv) preventing, by the client device, the user from performing, using the client application, a second predefined action. The method further includes logging and reporting a completion of the operational routine.

### BACKGROUND

Traditional location-based actions may be limited to sensing service operators' (also referred to as “field operators”, “mobile workers”, and “users”) geographical coordinates as they enter and exit geofenced locations, and sending alerts based on the coordinates. At the service locations, substantial amounts of time and manual work are usually required on part of the operators for completing procedural routines such as filling surveys, timesheets and work-orders over and above the actual performance of the services. In terms of productivity, this approach, needing human training and retraining, may be difficult to manage and scale up. As for effectiveness, there are chances of error and fraudulent non-compliances that may be damaging for the service organization. Most of the service operations may benefit if the routine field operations and the operators performing these routine operations are guided automatically on-site, at scale and across various service conditions.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1 is a block diagram illustrating an example system for automatically performing routine location-based operations, in accordance with an embodiment of this disclosure.

FIG. 2A is a flow diagram illustrating a method for automatically performing routine location-based operations of the system of FIG. 1, in accordance with an embodiment of this disclosure.

FIG. 2B is a flow diagram illustrating a method for automatically performing routine location-based operations of the system of FIG. 1, in accordance with an embodiment of this disclosure.

FIG. 3A is a block diagram illustrating an exemplary electronic device according to an example implementation.

FIG. 3B is a block diagram of an exemplary deployment environment according to an example implementation.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Techniques disclosed herein enable a hybrid architecture including automatically performing routine operations in location-based client mode and supervising and configuring the automatic performance of the routine operations in a centralized server mode. The hybrid architecture includes a server and a client device digitally connected with the server. The hybrid architecture provides for receiving service related information at the server from the client device. The service related information may relate to a current location and/or a current time and/or a current status related to a service location. The client device may have a client application pre-installed. Responsive to the information related to the current location, the current time, and the current status, the server may configure the client device to automatically perform several operational routines at the service location. The operational routines may include performing local actions at the current location, performing backend actions, prompting a user to perform, using the client application, a first predetermined type of actions, and preventing the user from performing, using the client application, a second predetermined type of actions.

A procedure for automatically performing routine location-based operations includes receiving, at a server, information related to a current location, a current time, and a current status from a client device having a client application. The procedure also includes responsive to the information related to the current location, the current time, and the current status from the client device, configuring, by the server, the client device to automatically perform an operational routine. The operational routine includes at least one of: (i) performing, by the client device, a local action at the current location, (ii) performing, by the client device, a backend action, (iii) prompting, by the client device, a user to perform, using the client application, a first predefined action, and (iv) preventing, by the client device, the user from performing, using the client application, a second predefined action. The procedure further includes logging and reporting a completion of the operational routine.

The performing, by the client device, a local action at the current location includes (1) detecting, by the client device, if the user has lingered within or outside a geofence defined around the current location beyond, respectively, a predefined presence or a predefined absence period, (2) prompting, by the client device, the user to update the current status, (3) prompting, by the client device, the user to take a corrective action based on the current status or the update from the user, and (4) reporting, by the client device, a process administrator based on the current status or the update from the user.

The performing, by the client device, a backend action includes tracking information related to an asset or a resource or a warehouse within a predefined distance from the current location and issuing an action instruction, related to the asset or the resource or the warehouse, to the user.

The first predefined action includes executing a work-plan associated with the current location. The second predefined action includes updating a service related information on the client application when the user is beyond a geofence defined around the current location.

Configuring, by the server, the client device to automatically perform an operational routine further includes providing the client device with all data necessary for the client device to perform the operational routine when the client device has no connection to a data network.

The computer-implemented method may further include configuring the client device with information about the operational routine when the client device returns to an online state from an off-line state.

In an aspect of the disclosed subject matter, a system is disclosed for automatically performing routine location-based operations. The system includes a processor, a server application digitally connected with the processor, a client device having a client application. The client device is digitally connected with the processor. The system also includes a non-transitory machine-readable storage medium that provides instructions that, if executed by the processor, are configurable to cause the system to perform several operations. The operations include (1) sending, by a client application, information related to a current location, a current time, and a current status from a client device to a server application, (2) responsive to information related to the current location, the current time, and the current status from the client device, configuring the client device, by the server application, to automatically perform an operational routine, and (3) logging and reporting, by the server application, a completion of the operational routine. The operational routine includes at least one of: (i) performing, by the client device, a local action at the current location, (ii) performing, by the client device, a backend action, (iii) prompting, by the client device, a user to perform, using the client application, a first predefined action, and (iv) preventing, by the client device, the user from performing, using the client application, a second predefined action.

In an aspect of the disclosed subject matter, a non-transitory machine-readable storage medium is disclosed that includes instructions that, if executed by a processor, are configurable to cause said processor to perform operations and methods for automatically performing routine location-based operations.

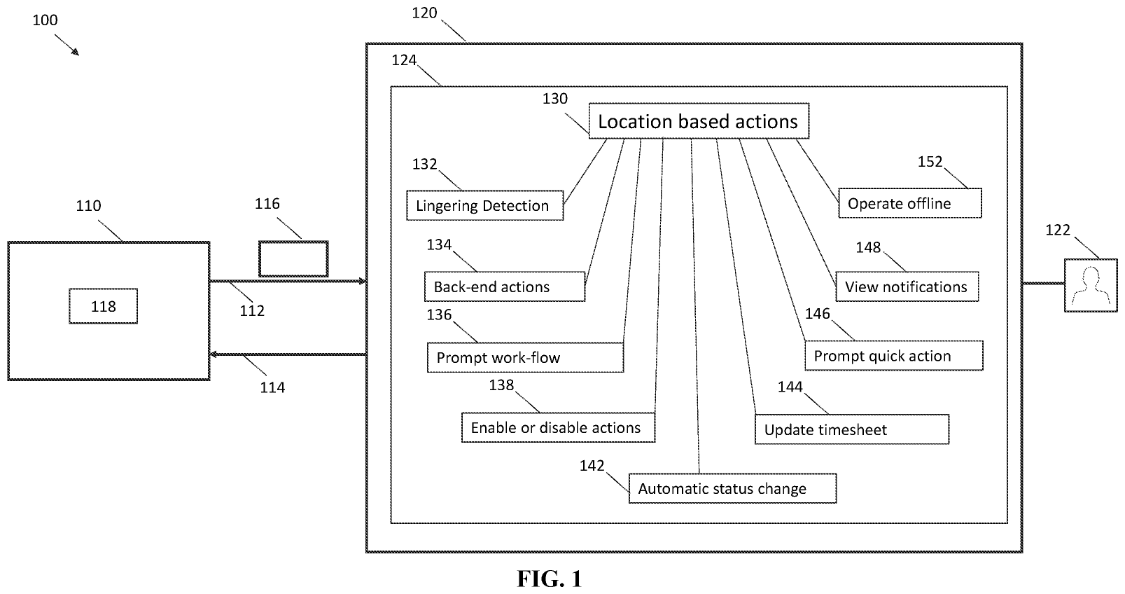

FIG. 1 is a block diagram illustrating a system 100 for automatically performing routine location-based operations, in accordance with an embodiment of this disclosure. The system 100 includes a server 110 and a client device 120 digitally connected and communicating with the server 110. The server 110 may be a cloud-native web server such as Apache, Nginx and the like or a database server such as MySQL, PostgreSQL and the like. The client device 120 may be a mobile phone or a personal digital assistant in possession of or carried by a mobile worker 122.

The server 110 prepares configuration files (also referred to as “priming files”) 116 that are sent to the client device 120 as communication 112. Communications from the client device 120 are received at the server 110 as communication 114. The client device 120 may have a pre-installed client application 124 that performs a number of location-based actions 130. The location-based actions 130 may include lingering detection 132, backend actions 134, work-flow prompting 136, enabling or disabling local actions 138, automatic status change 142, updating timesheet 142, quick action prompting 146, viewing notifications 148, operating offline 152 and the like.

Referring to FIG. 1, information related to a current location, a current time, and a current status and originating from the client device 120 may be received at the server 110. Responsive to the information related to the current location, the current time, and the current status, the client device 120 may be configured by the client server 110 to automatically perform one or more operational routines. Specifically, the client device 120 may be configured to perform the operational routines locally, at the current service location.

Operationally, example application data objects 118 such as “service appointment”, “work order”, “work order line item”, “territory location” may be natively and seamlessly installed on the server 110. As is commonly known in database management art, the application data objects 118 are designed to perform operations such as reading, updating, inserting, or deleting data from a database and they facilitate data access and manipulation by providing methods and properties to interact with underlying data sources. Referring to FIG. 1, application data objects 118 may have location-based actions 130 (also referred to as “LBA” or “actions”) associated with them. The actions 130 may be supported on the server 110 without any required setup other than their behavior being customized, if needed, by a process supervisor. The actions 130 may be triggered based on a location, a time of day or an expression of properties associated with the client device 120. The actions 130 may receive additional data which their triggered functions may be based on.

The location-based actions 130 may be configured to either automatically perform a number of local functions, or trigger a number of backend functions, or prompt a user to perform a first type of actions, or prevent a user from performing a second type of actions. The location-based actions 130 may address a predefined list of operational objectives and each of the location-based actions 130 may have corresponding unique set of input fields that are linked with the corresponding application data objects 118. In an instance, the triggering of the actions 130 may be configured based on an invocation time (or day) registered by the client device 120. Typically, the invocation time may not be editable by a mobile worker 122 on the client device 120. In an instance, the triggering of the location-based actions 130 may be configured based on the location of the client device 120, such as when a mobile worker 122 is entering a service location or leaving the service location. The service location may typically be defined in terms of a geofenced area characterized by a radius parameter and a time window for access.

In an example, the client device 120 may detect in real time if a mobile worker 122 has lingered (or stayed on) within, or outside a service location, beyond, respectively, a predefined presence or a predefined absence period, as in 132. If the mobile worker has remained at a service location for too long or beyond a predefined threshold time interval, the client device 120 may enquire the mobile worker 122, via an alerting mechanism such as vibration, flashing lights, sound alarms and the like, about the safety of the situation and whether the worker 122 requires any help or assistance. Further, the client device 120 may prompt the mobile worker 122 to update his/her current status and perform a corrective action. Based on the update from the mobile worker 122, the client device 120 may report the current status to a process supervisor. If the mobile worker 122 is working, for example, in a high-altitude and/or unsafe situation such as a cave, a pool, an elevator shaft and the like, for too long, the client device 120 may enquire about the worker's safety and health, suggest taking a break from work and inform a process supervisor. In a similar manner, the client device 120 may detect in real time if a mobile worker 122 has been absent from or lingered outside a service location and has not yet recorded the absence. The client device 120 may prompt the worker 122 to create an appropriate record of absence.

Referring back to FIG. 1, the client device 120 may perform a backend action, as in 134, while the mobile worker 122 is attending and engaged on a task at a service location. The backend action 134 may include tracking information related to an asset or a resource or a warehouse within a predefined distance from the current service location. The backend action 134 may also include issuing an action instruction related to the asset or the resource or the warehouse to the mobile worker 122. The server 110 may configure the mobile device 120 to detect in real time resources that are remaining or staying on in a service location, un-assigned to an ongoing work. If a mobile worker 122 is working at the same or a nearby service location, the client device 120 may notify the mobile worker 122 to attend the un-assigned asset.

Referring once again to FIG. 1, the client device 120 may prompt a mobile worker 122 to perform, using the client application 124, a predefined local action 136 at the service location. The predefined local action 136 may include executing a work-plan associated with the current location. In an example, a mobile worker 122 arriving at a service location may be enabled to readily and automatically launch a work-plan. In operation, a mobile worker 122 approaching a service location may receive notifications about how to execute a work-plan at the service location. The mobile worker 122 may tap or open the notification on the client device 120 and the client device 120 may instruct the mobile worker 122 to begin with a site survey, for example, using a customized program installed on the client application 124. The client device 120 may further instruct the mobile worker 122 to open other specific programs related to the work-plan and follow the steps to complete the work-plan.

In an example, existing mobile workers working at a service location on a regular schedule may be familiar with a sequence of steps. A new and unfamiliar worker 122, however, may need additional supporting information when assigned to the work for the first time. The client device 120 may provide the supporting information, for example, in the form of a description of the job, the process steps of the job, suggestions for execution and an expert's contact information for any help. The new worker 122 entering and/or leaving the service location may readily receive such supporting information. The supporting information may also specify the “running interval” i.e., the frequency at which the action needs to be performed or repeated. Depending on the nature of the work, the “running interval” may be “one time” or “daily” or “every alternate week day” etc. Further, the server 110 may configure the client device 120 to operationalize and monitor the running intervals and the sequence of steps associated with the work-plan, as per service process requirement. In an example, a mobile worker 122 approaching a sensitive service location may be alerted of the additional safety routines or cautionary procedures he/she needs to comply with. In summary, entering or leaving a service location with an associated automated work-plan may enable a mobile worker 122 to perform operational routines safely, independently and effectively.

Referring back to FIG. 1, in one embodiment, the client device 120 may prevent a mobile worker 122 from performing, using the client application, a number of predefined actions 138. The prevented actions 138 may include updating a service related information on the client application 124 outside a service location. In some cases, the “edit record” features may be abused and a mobile worker 122 may try to update or alter service related details while being away from the service location. As a preventive measure, the server 110 may configure the client device 120 to disable capturing and uploading service related photographic images when the mobile worker 122 is outside the service location. The client device 120 may also be configured to label a photographic image with the latitude and the longitude of a source site, as a watermark, to prevent fraudulent updates of information.

In an example, local actions may be disabled when a mobile worker 122 is outside a service location, and enabled when a mobile worker 122 is inside the service location. To elaborate further, the server 110 may program an action 138 to detect the proximity of a mobile worker 122 in relation to the service location and configure the client device 120 to prevent workers 122 from updating records beyond a threshold distance from the service location. If a mobile worker 122, for example, is outside the service location and tries to access a work-plan, the worker 122 may view the work-plan greyed out with an example notification “This is an onsite-only work-plan”. Again, when the mobile worker 122 reaches inside the service location and tries to access the work-plan, the worker 122 may view the work-plan as active and ready to access. In another instance, when a mobile worker 122 is still inside the service location and heading outside, an example message may display “Edit record features are not accessible outside this service location”.

Referring to FIG. 1, the client device 120 may automatically change the status of a mobile worker 122 or of a service appointment, as in 142. Further, the client device 120 may automatically prompt the mobile worker 122 to update procedural documents, such as a survey, a timesheet, a log, a report and the like, as in 144. Completion of service appointments may typically trigger automatic changes of status 142. The server 110 may configure the client device 120 to automatically notify a process supervisor when the mobile worker 122 enters, leaves or lingers on around a service location. Features such as, automatic change of status 142 and prompting to update procedural documents 144 may eliminate or reduce the need of manually and painstakingly updating the changes in status.

The server 110 may configure the client device 120 to record a mobile worker's status transitions across several work orders and automatically notify the process supervisor accordingly. For example, a mobile worker 122, while driving to a first service appointment, may update the status of the service appointment to “en-route”. On arriving at a first service location, the mobile worker 122 may mark the status as “on location”. The mobile worker 122 may complete the first job and update the first service appointment status to “in-tow”, proceed to a second service appointment, complete the second job and update the second service appointment status to “in-tow”, arrive at a third service location, update the first service appointment to “tow complete”, and update the second service appointment to “tow complete”. Location-based actions 142 and 144 may record these transitions automatically and update all related procedural documents without substantial manual input from the mobile worker 122.

Referring to FIG. 1, the server 110 may configure the client device 120 to automatically notify the mobile worker 122 to execute quick actions 146 when a mobile worker 122 enters or exits or reaches a predetermined threshold distance from a service location. When the mobile worker 122 taps a notification on the client device 120, the client device 120 may require the mobile worker 122 to begin with an initial job assessment checklist and complete the subsequent steps as displayed and/or prompted on a display screen.

As mentioned earlier, the server 110 may characterize a service location in terms of a geofence having a predetermined radius. Programming the location-based actions 130 based on the geofences allows process supervisors to automate the operational routines in sync with current time and current location, to customize the criteria for monitoring, controlling and completing a job, and to display instruction messages to the mobile worker 122 in a timely and appropriate sequence. When in the foreground, the client application 124, may display a visible message instructing the mobile worker 122 to open a display screen of the mobile device 120 for the details of the service appointment. When in the background, the client application 124, may display an appropriate push-notification message instructing the mobile worker 122 how to proceed forward. In case there are multiple service appointments within a geofence, the client application 124 may prompt and guide the mobile worker 122 to prioritize one appointment over the others. In an example, the quick actions 146 may be activated only when the service appointment status does not belong to any of the status categories such as “completed” or “cannot complete” or “canceled” and the like.

Referring to FIG. 1, the server 110 may configure the client device 120 to display view-only notifications 148 based on a specific location and/or a specific time. For example, the client device 120 may display an example view-only notification “Welcome”, when a mobile worker 122 enters the head office of the service organization. Similarly, the mobile worker 122 may receive a view-only notification “Have a great day” from the client device 120 as he/she sets out on the first service appointment of the day. The server 110 may configure the client device 120 to distinguish between different types of view-only notifications 148. For example, a mobile worker 122 arriving at a first location may be instructed by a view-only notification 148 to complete a safety check before starting the job while another mobile worker 122 may be instructed by another view-only notification 148 to attend an asset that requires immediate maintenance. The server 110 may configure the client device 120 to capture the latitude and longitude of the exact location where an action is triggered, in order to send the process supervisor an evidence of the mobile worker's actual location.

The server 110 may configure the client device 120 to record and report completion of an operational routine. Based on the records and reports generated by the client device 120, the server 110 may monitor the time history of the location-based actions 130 and analyze the field performance of a mobile worker 122. Process supervisors may further analyze the effectiveness of location-based actions 130, prepare time utilization reports for the mobile workers 122 and, thereby, optimize scheduling and dispatching of the services.

The server 110 may configure the client device 120 to trigger the location-based actions 130 based on territory zones. In case a mobile worker 122 is in the vicinity of more than one service locations, the server 110 may configure the client device 120 to prompt and guide a mobile worker 122 to prioritize and sequence the service locations. For example, the client device 120 may instruct the mobile worker 122 to proceed to a first service appointment that is located at a first location and scheduled to begin at a first hour, and then proceed to a second service appointment that is located at a second location and scheduled to begin at a second hour, and then proceed to a third service appointment that is located at a third location and scheduled to begin at a third hour. The mobile worker 122 may be automatically tracked and instructed via the client device 120 until the whole service plan is complete.

The server 110 may configure the client device 120 not to notify a mobile worker 122 when the worker 122 is merely driving by or crossing an area. This may prevent unnecessary or false notifications when a mobile worker 122 does not need to actually visit or work at a service location. Further, the server 110 may configure the client device 120 to send action notifications only when the mobile worker 122 is stationary so that the worker is not distracted from driving or other attention-intensive engagements. Similarly, when a mobile worker 122 is preparing or is en-route to the next service appointment, the worker 122 may be notified ahead of time, before the travel begins, to complete necessary prework and check the tools and inventory needed for the job.

The server 110 may configure the client device 120 to control the beginning and the end of tracking a mobile worker 122 or specify an interval or a condition for tracking so that the mobile worker 122 is not distracted unnecessarily. Capturing the location of an asset a mobile worker 122 just installed may require the mobile worker 122 to go through multiple steps and to upload an image (as watermark) of the asset or other location-based information. While traveling to sensitive locations, a mobile worker 122 may be alerted about adopting proper protection such as hazard suits, put-away articles and appropriate safety routines or procedures.

Referring to FIG. 1, the client device may execute all or most of the location-based actions 130 in an offline condition, if need be, as in 152. In other words, the server 110 may configure the client device 120 to automatically perform an operational routine and provide the client device 120 with all data necessary to perform the operational routine when the client device 120 has no connection to a data network in difficult service conditions such as in a cave or a pool or down an elevator shaft. Further, the client device may be primed with information about the operational routine when the client device returns to an online state from an off-line state. The priming method may include priming with relevant data via full priming, briefcase priming, delta priming and the like.

As is commonly known in database management art, “priming” typically refers to a process of initializing or populating a client-side cache with data from a server-side database. “Full priming” involves populating the client-side cache with a full set of data from the server-side database. “Briefcase priming” is a strategy where the client-side cache is initialized with a subset of data that is relevant to a specific user or use case. Instead of loading the entire dataset, only the relevant portions are cached. “Delta priming” focuses on populating the client-side cache with only the changes or updates that have occurred since the last synchronization.

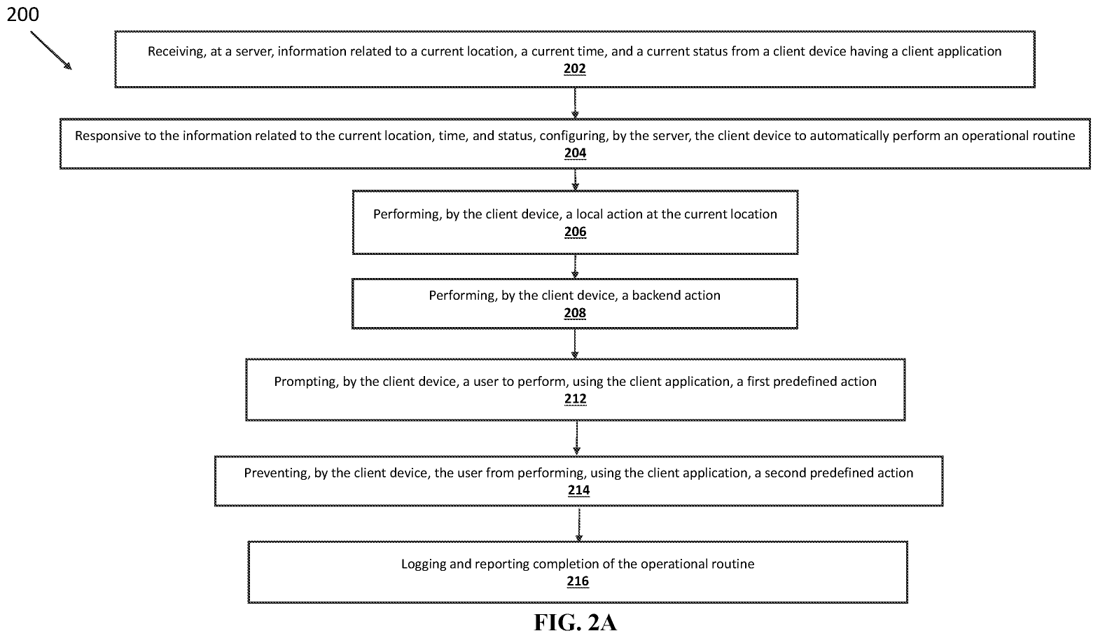

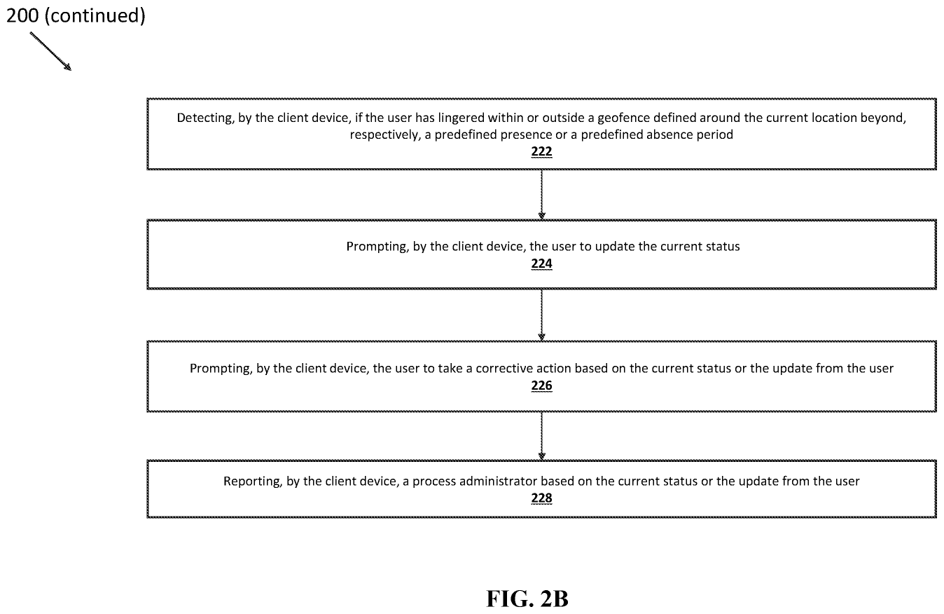

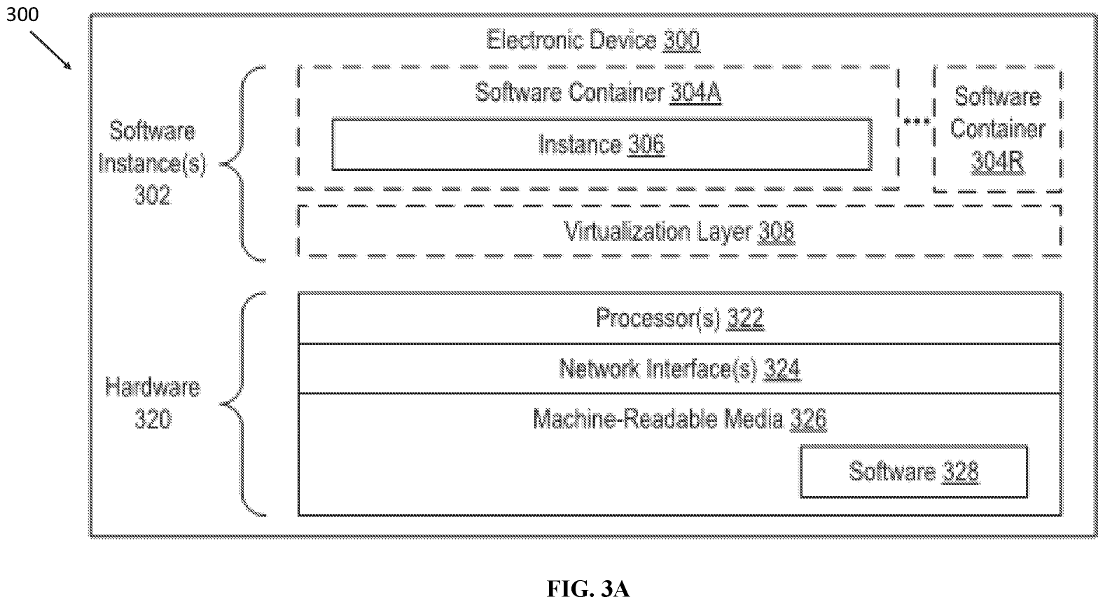

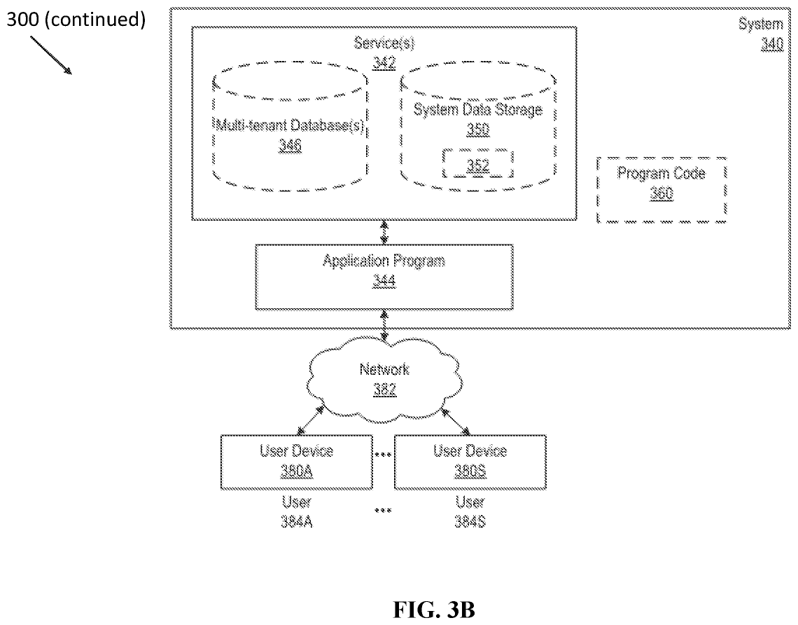

FIG. 2A is a flow diagram illustrating a computer-implemented method 200 for automatically performing routine location-based operations of the system of FIG. 1, as disclosed herein. The method 200 may be performed, for example, by a system as shown in FIG. 1 operating in conjunction with the hardware as shown in FIGS. 3A and 3B and/or by software executing on a server or distributed computing platform. Although the steps of method 200 are presented in a particular order, this is only for simplicity.

The computer-implemented method 200 may include, as in step 202, receiving, at a server, information related to a current location, a current time, and a current status from a client device having a client application. At 204, responsive to the information related to the current location, the current time, and the current status from the client device, the client device is configured by the client server to automatically perform one of several operational routines. At 206, the client device performs a local action at the current location.

At 208, the client device performs a backend action. The backend action may include tracking information related to an asset or a resource or a warehouse within a predefined distance from the current location and issuing an action instruction, related to the asset or the resource or the warehouse, to the mobile worker.

At 212, the client device prompts a mobile worker to perform, using the client application, a first predefined action. The first predefined action may include executing a work-plan associated with the current location.

At 214, the client device prevents the mobile worker from performing, using the client application, a second predefined action. The second predefined action may include updating a service related information on the client application when the mobile worker is beyond a geofence defined around the current location. Further, at 216, the client device logs and reports a completion of the operational routine.

FIG. 2B is a flow diagram illustrating a computer-implemented method 200 for automatically performing routine location-based operations of the system of FIG. 1, as disclosed herein. At 222, the client device detects if the mobile worker has lingered within or outside a geofence defined around the current location beyond, respectively, a predefined presence or a predefined absence period. At 224, the client device prompts the mobile worker to update the current status. At 226, the client device may prompt the mobile worker to take a corrective action based on the current status or the update from the mobile worker. At 228, the client device reports the current status to a process administrator based on the update from the mobile worker.

In the context of service operations across field locations, traditional location-based actions may be limited to operating based on field workers equipped with mobile devices, entering into and exiting out of geofenced locations, and sending alerts based on the coordinates of the mobile devices. The hybrid architecture of the present disclosure enables automation of many operational routines performed at service locations. Location-based actions may be configured on a server and downloaded to the client devices. The location-based operations that run on the client devices may automatically perform several routine functions, including detecting when the client device lingers at a location for too long and triggering actions when lingering is detected, disabling certain functionality on the client device to prevent fraud by preventing a worker from using the client device uploading images, notes, and/or reports on a server if the client device is not within a specified distance of a service location, and automated warehouse management that tracks requests for equipment from workers and movements of equipment by workers.

Mobile workers, transitioning in, out and around a service location, may be automatically guided on operational routines, at scale, to deliver right functionality at right time. Leveraging location information of the mobile workers and providing them the required information, toolset and instructions when they are in the vicinity of service locations or when they arrive the service locations are likely to increase operational efficiency of field services and improve customer satisfaction. These functionalities being available even when the client device is entirely offline, such as when the worker goes to challenging locations and/or in difficult service conditions that has no cellular service or available Wi-Fi connections, adds to the value of the solutions.

One or more parts of the above implementations may include software. Software is a general term whose meaning may range from part of the code and/or metadata of a single computer program to the entirety of multiple programs. A computer program (also referred to as a program) includes code and optionally data. Code (sometimes referred to as computer program code or program code) includes software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices may transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (typically, though not necessarily an individual person) that uses an electronic device. Software and/or services may use credentials to distinguish different accounts associated with the same and/or different users. Users may have one or more roles, such as administrator, programmer/developer, and end user roles. As an administrator, a user typically uses electronic devices to administer them for other users, and thus an administrator often works directly and/or indirectly with server devices and client devices. The term “consumer” refers to another computer service that is running the reusable software components of the system o FIG. 1.

FIG. 3A is a block diagram illustrating an electronic device 300 according to some example implementations. FIG. 3A includes hardware 320 including a set of one or more processor(s) 322, a set of one or more network interfaces 324 (wireless and/or wired), and machine-readable media 326 having stored therein software 328 (which includes instructions executable by the set of one or more processor(s) 322). The machine-readable media 326 may include non-transitory and/or transitory machine-readable media. Each of the previously described clients and server components may be implemented in one or more electronic devices 300. In one implementation: 1) each of the clients is implemented in a separate one of the electronic devices 300 (e.g., in end user devices where the software 328 represents the software to implement clients to interface directly and/or indirectly with server components (e.g., software 328 represents a web browser, a native client, a portal, a command-line interface, and/or an application programming interface (API) based upon protocols such as Simple Object Access Protocol (SOAP), Representational State Transfer (REST), etc.)); 2) server components is implemented in a separate set of one or more of the electronic devices 300 (e.g., a set of one or more server devices where the software 328 represents the software to implement the framework for providing additional security to protected fields in protected views); and 3) in operation, the electronic devices implementing the clients and server components may be communicatively coupled (e.g., by a network) and may establish between them (or through one or more other layers and/or other services) connections for submitting requests to server components and returning responses to the clients. Other configurations of electronic devices may be used in other implementations (e.g., an implementation in which the client and server components are implemented on a single one of electronic device 300).

During operation, an instance of the software 328 (illustrated as instance 306 and referred to as a software instance; and in the more specific case of an application, as an application instance) is executed. In electronic devices that use compute virtualization, the set of one or more processor(s) 322 typically execute software to instantiate a virtualization layer 308 and one or more software container(s) 304A-304R (e.g., with operating system-level virtualization, the virtualization layer 308 may represent a container engine (such as Docker Engine by Docker, Inc. or rkt in Container Linux by Red Hat, Inc.) running on top of (or integrated into) an operating system, and it allows for the creation of multiple software containers 304A-304R (representing separate user space instances and also called virtualization engines, virtual private servers, or jails) that may each be used to execute a set of one or more applications; with full virtualization, the virtualization layer 308 represents a hypervisor (sometimes referred to as a virtual machine monitor (VMM)) or a hypervisor executing on top of a host operating system, and the software containers 304A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 328 is executed within the software container 304A on the virtualization layer 308. In electronic devices where compute virtualization is not used, the instance 306 on top of a host operating system is executed on the “bare metal” electronic device 300. The instantiation of the instance 306, as well as the virtualization layer 308 and software containers 304A-304R if implemented, are collectively referred to as software instance(s) 302.

Alternative implementations of an electronic device may have numerous variations from that described above. For example, customized hardware and/or accelerators might also be used in an electronic device.

FIG. 3B is a block diagram of a deployment environment according to some example implementations. A system 340 includes hardware (e.g., a set of one or more server devices) and software to provide service(s) 342, including server components. In some implementations the system 340 is in one or more datacenter(s). These datacenter(s) may be: 1) first party datacenter(s), which are datacenter(s) owned and/or operated by the same entity that provides and/or operates some or all of the software that provides the service(s) 342; and/or 2) third-party datacenter(s), which are datacenter(s) owned and/or operated by one or more different entities than the entity that provides the service(s) 342 (e.g., the different entities may host some or all of the software provided and/or operated by the entity that provides the service(s) 342). For example, third-party datacenters may be owned and/or operated by entities providing public cloud services.

The system 340 is coupled to user devices 380A-380S over a network 382. The service(s) 342 may be on-demand services that are made available to one or more of the users 384A-384S working for one or more entities other than the entity which owns and/or operates the on-demand services (those users sometimes referred to as outside users) so that those entities need not be concerned with building and/or maintaining a system, but instead may make use of the service(s) 342 when needed (e.g., when needed by the users 384A-384S). The service(s) 342 may communicate with each other and/or with one or more of the user devices 380A-380S via one or more APIs (e.g., a REST API). In some implementations, the user devices 380A-380S are operated by users 384A-384S, and each may be operated as a client device and/or a server device. In some implementations, one or more of the user devices 380A-380S are separate ones of the electronic device 300 or include one or more features of the electronic device 300.

In some implementations, the system 340 is any generic network interface management system that uses web interfaces and includes server application components, client application components and a browser extension. The system and method provide for authenticating the end user via a browser extension that needs to be available in the intended user's web browser. The input to the system and method is the information about the views and its specific fields or any other part that is rendered and need to be protected, as provided by the application owner. Typical generic examples are Java clients and applications, Python based frameworks, libraries for client applications implementing the logic described above.

In some implementations, the system 340 is any generic network interface management system that uses web interfaces and includes server application components, client application components and a browser extension. The system and method provide for authenticating the end user via a browser extension that needs to be available in the intended user's web browser. The input to the system and method is the information about the views and its specific fields or any other part that is rendered and need to be protected, as provided by the application owner. Typical generic examples are Java clients and applications, Python based frameworks, libraries for client applications implementing the logic described above.

Network 382 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4th generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 340 and the user devices 380A-380S.

Each user device 380A-380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 340. For example, the user interface device may be used to access data and applications hosted by system 340, and to perform searches on stored data, and otherwise allow one or more of users 384A-384S to interact with various GUI pages that may be presented to the one or more of users 384A-384S. User devices 380A-380S might communicate with system 340 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 380A-380S might include an HTTP client, commonly referred to as a “browser,” for sending and receiving HTTP messages to and from server(s) of system 340, thus allowing users 384A-384S of the user devices 380A-380S to access, process and view information, pages and applications available to it from system 340 over network 382.

In the above description, numerous specific details such as resource partitioning/sharing/duplication implementations, types and interrelationships of system components, and logic partitioning/integration choices are set forth in order to provide a more thorough understanding. Embodiments disclosed herein may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art may know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is illustrative and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and may be practiced with modification and alteration within the spirit and scope of the appended claims. The description is thus illustrative instead of limiting.

What is claimed is:

1. A computer-implemented method comprising:
receiving, at a server, information related to a current location, a current time, and a current status from a client device having a client application;
responsive to the information related to the current location, the current time, and the current status from the client device, configuring, by the server, the client device to automatically perform an operational routine, the operational routine comprising at least one of:
performing, by the client device, a local action at the current location,
performing, by the client device, a backend action,
prompting, by the client device, a user to perform, using the client application, a first predefined action, and
preventing, by the client device, the user from performing, using the client application, a second predefined action; and
logging and reporting a completion of the operational routine.

2. The computer-implemented method of claim 1, wherein the performing, by the client device, a local action at the current location comprises:
detecting, by the client device, if the user has lingered within or outside a geofence defined around the current location beyond, respectively, a predefined presence or a predefined absence period;
prompting, by the client device, the user to update the current status;
prompting, by the client device, the user to take a corrective action based on the current status or the update from the user; and
reporting, by the client device, a process administrator based on the current status or the update from the user.

3. The computer-implemented method of claim 1, wherein the performing, by the client device, a backend action comprises tracking information related to an asset or a resource or a warehouse within a predefined distance from the current location and issuing an action instruction, related to the asset or the resource or the warehouse, to the user.

4. The computer-implemented method of claim 1, wherein the first predefined action comprises executing a work-plan associated with the current location.

5. The computer-implemented method of claim 1, wherein the second predefined action comprises updating a service related information on the client application when the user is beyond a geofence defined around the current location.

6. The computer-implemented method of claim 1, wherein configuring, by the server, the client device to automatically perform an operational routine further comprises providing the client device with all data necessary for the client device to perform the operational routine when the client device has no connection to a data network.

7. The computer-implemented method of claim 1 further comprising configuring the client device with information about the operational routine when the client device returns to an online state from an off-line state.

8. An apparatus comprising:
a processor;
a server application digitally connected with the processor;
a client device having a client application, the client device digitally connected with the processor;
a non-transitory machine-readable storage medium that provides instructions that, if executed by the processor, are configurable to cause the apparatus to perform operations comprising:
receiving information related to a current location, a current time, and a current status from a client device having a client application;
responsive to the information related to the current location, the current time, and the current status from the client device, automatically performing an operational routine, the operational routine comprising at least one of:
performing, by the client device, a local action at the current location,
performing, by the client device, a backend action,
prompting, by the client device, a user to perform, using the client application, a first predefined action, the user authenticated to interact with the client application, and
preventing, by the client device, the user from performing, using the client application, a second predefined action; and
logging and reporting completion of the operational routine.

9. A non-transitory machine-readable storage medium that provides instructions that, if executed by a processor, are configurable to cause said processor to perform operations comprising:
receiving information related to a current location, a current time, and a current status from a client device having a client application;
responsive to the information related to the current location, the current time, and the current status from the client device, automatically performing an operational routine, the operational routine comprising at least one of:
performing, by the client device, a local action at the current location,
performing, by the client device, a backend action,
prompting, by the client device, a user to perform, using the client application, a first predefined action, the user authenticated to interact with the client application, and
preventing, by the client device, the user from performing, using the client application, a second predefined action; and
logging and reporting completion of the operational routine.

10. A computer-implemented method comprising:
sending information related to a current location, a current time, and a current status from a client device to a server application;
receiving, from the server application, by the client device, configuration for automatically performing an operational routine on the client device, the operational routine comprising at least one of:
performing a local action at the current location,
performing a backend action,
prompting a user to perform a first predefined action with the client device, and
preventing the user from performing a second predefined action with the client device; and
logging and reporting, by the server application, a completion of the operational routine.

11. The computer-implemented method of claim 10, wherein the performing a local action at the current location comprises:
detecting if the user has lingered within or outside a geofence defined around the current location beyond, respectively, a predefined presence or a predefined absence period;
prompting the user to update the current status;
prompting the user to take a corrective action based on the current status or the update from the user; and
reporting to a process administrator based on the current status or the update from the user.

12. The computer-implemented method of claim 10, wherein the performing a backend action comprises tracking information related to an asset or a resource or a warehouse within a predefined distance from the current location and issuing an action instruction, related to the asset or the resource or the warehouse, to the user.

13. The computer-implemented method of claim 10, wherein the first predefined action comprises executing a work-plan associated with the current location.

14. The computer-implemented method of claim 10, wherein the second predefined action comprises updating a service related information on the client application when the user is beyond a geofence defined around the current location.

15. The computer-implemented method of claim 10, wherein the configuration for automatically performing an operational routine on the client device further comprises all data necessary for the client device to perform the operational routine when the client device has no connection to a data network.

16. The computer-implemented method of claim 10, further comprising receiving, by the client device, from the server application, information about the operational routine when the client device returns to an online state from an off-line state.

17. An apparatus comprising:
a processor;
a server application digitally connected with the processor;
a client device having a client application, the client device digitally connected with the processor;
a non-transitory machine-readable storage medium that provides instructions that, if executed by the processor, are configurable to cause the apparatus to perform operations comprising:
sending information related to a current location, a current time, and a current status from a client device to a server application;
receiving, from the server application, by the client device, configuration for automatically performing an operational routine on the client device, the operational routine comprising at least one of:
performing a local action at the current location,
performing a backend action,
prompting a user to perform a first predefined action with the client device, and
preventing the user from performing a second predefined action with the client device; and
logging and reporting, by the server application, a completion of the operational routine.

18. A non-transitory machine-readable storage medium that provides instructions that, if executed by a processor, are configurable to cause said processor to perform operations comprising:
sending information related to a current location, a current time, and a current status from a client device to a server application;
receiving, from the server application, by the client device, configuration for automatically performing an operational routine on the client device, the operational routine comprising at least one of:
performing a local action at the current location,
performing a backend action,
prompting a user to perform a first predefined action with the client device, and
preventing the user from performing a second predefined action with the client device; and
logging and reporting, by the server application, a completion of the operational routine.

19. A computer-implemented method comprising:
sending, by a client application, information related to a current location, a current time, and a current status from a client device to a server application;
responsive to information related to the current location, the current time, and the current status from the client device, configuring the client device, by the server application, to automatically perform an operational routine, the operational routine comprising at least one of:
performing, by the client device, a local action at the current location,
performing, by the client device, a backend action,
prompting, by the client device, a user to perform, using the client application, a first predefined action, and
preventing, by the client device, the user from performing, using the client application, a second predefined action; and
logging and reporting, by the server application, a completion of the operational routine.

20. The computer-implemented method of claim 19, wherein the performing, by the client device, a local action at the current location comprises:
detecting, by the client device, if the user has lingered within or outside a geofence defined around the current location beyond, respectively, a predefined presence or a predefined absence period;
prompting, by the client device, the user to update the current status;
prompting, by the client device, the user to take a corrective action based on the current status or the update from the user; and
reporting, by the client device, a process administrator based on the current status or the update from the user.

21. The computer-implemented method of claim 19, wherein the performing, by the client device, a backend action comprises tracking information related to an asset or a resource or a warehouse within a predefined distance from the current location and issuing an action instruction, related to the asset or the resource or the warehouse, to the user.

22. The computer-implemented method of claim 19, wherein the first predefined action comprises executing a work-plan associated with the current location.

23. The computer-implemented method of claim 19, wherein the second predefined action comprises updating a service related information on the application when the user is beyond a geofence defined around the current location.

24. The computer-implemented method of claim 19, wherein configuring, by the server, the client device to automatically perform an operational routine further comprises providing the client device with all data necessary for the client device to perform the operational routine when the client device has no connection to a data network.

25. The computer-implemented method of claim 24 further comprising configuring the client device with information about the operational routine when the client device returns to an online state from an off-line state.

26. An apparatus comprising:
a processor;
a server application digitally connected with the processor;
a client device having a client application, the client device digitally connected with the processor;
a non-transitory machine-readable storage medium that provides instructions that, if executed by the processor, are configurable to cause the apparatus to perform operations comprising:
sending, by a client application, information related to a current location, a current time, and a current status from a client device to a server application;
responsive to information related to the current location, the current time, and the current status from the client device, configuring the client device, by the server application, to automatically perform an operational routine, the operational routine comprising at least one of:
performing, by the client device, a local action at the current location,
performing, by the client device, a backend action,
prompting, by the client device, a user to perform, using the client application, a first predefined action, and
preventing, by the client device, the user from performing, using the client application, a second predefined action; and
logging and reporting, by the server application, a completion of the operational routine.

27. A non-transitory machine-readable storage medium that provides instructions that, if executed by a processor, are configurable to cause said processor to perform operations comprising:
sending, by a client application, information related to a current location, a current time, and a current status from a client device to a server application;
responsive to information related to the current location, the current time, and the current status from the client device, configuring the client device, by the server application, to automatically perform an operational routine, the operational routine comprising at least one of:
performing, by the client device, a local action at the current location,
performing, by the client device, a backend action,
prompting, by the client device, a user to perform, using the client application, a first predefined action, and
preventing, by the client device, the user from performing, using the client application, a second predefined action; and
logging and reporting, by the server application, a completion of the operational routine.
